(19) United States
(12) Patent Application Publication
(10) Pub. No.: US 2017/0191867 A1
(43) Pub. Date: Jul. 6, 2017

(54) INTEGRATING SPHERE COVER AND INTEGRATING SPHERE MODULE

(71) Applicant: MPI Corporation, Hsinchu County (TW)

(72) Inventors: Duen-Tsai Liau, Taichung City (TW); Hung-I Lin, Hsinchu County (TW)

(73) Assignee: MPI Corporation, Hsinchu County (TW)

(21) Appl. No.: 15/334,296

(22) Filed: Oct. 26, 2016

(30) Foreign Application Priority Data
Dec. 31, 2015 (TW) 104144569

(51) Int. Cl. G01J 1/02; G01J 1/04

(52) U.S. Cl. CPC G01J 1/0252; G01J 1/04; G01J 2001/0481

(57) ABSTRACT

An integrating sphere cover covering an integrating sphere having a light receiving entrance is provided and includes a first casing and a fixing assembly. The first casing partially covers the integrating sphere and includes a first opening where the light receiving entrance passes. A curvature radius of the first casing is greater than that of the integrating sphere. The fixing assembly is disposed at the first casing, and the first casing is fixed to the integrating sphere through the fixing assembly. The first casing or the fixing assembly includes a nozzle. When the first casing covers the integrating sphere, a first interval communicating with the first opening and the nozzle is between the first casing and the integrating sphere to form a first hollow intermediate layer. An air flow passes through the first hollow intermediate layer via the nozzle and the first opening. An integrating sphere module is also provided.

### CROSS-REFERENCE TO RELATED APPLICATION

This application claims the priority benefit of Taiwan application serial no. 104144569, filed on Dec. 31, 2015. The entirety of the above-mentioned patent application is hereby incorporated by reference herein and made a part of this specification.

### FIELD OF THE INVENTION

The invention relates to an integrating sphere cover and an integrating sphere module. More particularly, the invention relates to an integrating sphere cover and an integrating sphere module that allow the temperature of an integrating sphere not to easily increase.

### DESCRIPTION OF RELATED ART

With the progress of modern semiconductor science and technologies, light emitting diodes (LEDs) have been extensively used to provide light sources required by electronic apparatuses, such as traffic signs, large bulletin, scanners, liquid crystal displays, and so on.

After illumination light sources are completely manufactured and before they are dispatched from the factory, light intensity of the illumination light sources are often inspected through measurement instruments, so as to determine whether the illumination light sources are in normal operation. As to the measurement of the optical illumination devices, e.g., the LED, luminous flux and chromaticity are two crucial optical parameters. The luminous flux is relevant to the illumination area and is thus conventionally measured with use of an integrating sphere. The integrating sphere collects light entering the sphere and creates reflection effects within the sphere, so as to uniformize the light. The light intensity, e.g., the luminous flux, can be measured through a light detector arranged on the integrating sphere. In general, the integrating sphere is located close to the LED to increase the light collection rate.

However, during the optical inspection, the LED is often heated by a heating module, so as to perform a heat test. The neighboring integrating sphere is thus being heated together with the LED. The inner surface of the integrating sphere may be coated with barium sulfate or any other coating layer. Hence, when the integrating sphere is being heated, the coating layer may undergo chemical changes due to the heat, which may further affect the performance of the integrating sphere.

### SUMMARY OF THE INVENTION

The invention is directed to an integrating sphere cover that allows the temperature of an integrating sphere covered by the integrating sphere cover not to easily increase.

The invention is also directed to an integrating sphere module having said integrating sphere cover.

In an embodiment of the invention, an integrating sphere cover is adapted to cover at least one portion of an integrating sphere, and the integrating sphere includes a light receiving entrance. The integrating sphere cover includes a first casing and a fixing assembly. The first casing is adapted to partially cover the integrating sphere and includes a first opening, the light receiving entrance passes through the first opening, and a curvature radius of the first casing is greater than a curvature radius of the integrating sphere. The fixing assembly is disposed at the first casing, and the first casing is adapted to be fixed to the integrating sphere through the fixing assembly. The first casing or the fixing assembly includes a nozzle. When the first casing covers the integrating sphere, a first interval communicating with the first opening and the nozzle is between the first casing and the integrating sphere, so as to form a first hollow intermediate layer between the first casing and the integrating sphere, and an air flow passes through the first hollow intermediate layer via the nozzle and the first opening.

According to an embodiment of the invention, the fixing assembly includes a holder and a plurality of locking members locking the first casing to the holder, and the integrating sphere is adapted to be fixed to the holder.

According to an embodiment of the invention, the first casing is a heat insulating member and a material of the heat insulating member includes plastic, plastic steel, or backlite, or the first casing is a heat conductor and a material of the heat conductor includes metal.

According to an embodiment of the invention, a color code of an outer surface of the first casing is a combination of color codes greater than R60, G20, and B30.

According to an embodiment of the invention, the integrating sphere cover further includes a second casing adapted to partially cover the integrating sphere, and the second casing includes a second opening. The integrating sphere includes a light exit passing through the second opening, and a curvature radius of the second casing is greater than the curvature radius of the integrating sphere. The fixing assembly is disposed at the second casing, and the second casing is adapted to be fixed to the integrating sphere through the fixing assembly. When the second casing covers other portions of the integrating sphere, a second interval communicating with the second opening is between the second casing and the integrating sphere, so as to form a second hollow intermediate layer between the second casing and the integrating sphere. The first hollow intermediate layer communicates with the second hollow intermediate layer. The air flow passes through the first hollow intermediate layer and the second hollow intermediate layer via the nozzle, the first opening, and the second opening.

In an embodiment of the invention, an integrating sphere module includes an integrating sphere and an integrating sphere cover. The integrating sphere includes a light receiving entrance. The integrating sphere cover covers at least one portion of the integrating sphere and includes a first casing and a fixing assembly. The first casing partially covers the integrating sphere and includes a first opening. The light receiving entrance passes through the first opening, and a curvature radius of the first casing is greater than a curvature radius of the integrating sphere. The fixing assembly fixes relative positions of the first casing and the integrating sphere. The first casing or the fixing assembly includes a nozzle. A first interval communicating with the first opening and the nozzle is between the first casing and the integrating sphere, so as to form a first hollow intermediate layer between the first casing and the integrating sphere, and an air flow passes through the first hollow intermediate layer via the nozzle and the first opening.

According to an embodiment of the invention, the fixing assembly includes a holder and a plurality of locking members locking the first casing to the holder, and the integrating sphere is adapted to be fixed to the holder.

According to an embodiment of the invention, the first casing is a heat insulating member and a material of the heat insulating member includes plastic, plastic steel, or backlite, or the first casing is a heat conductor and a material of the heat conductor includes metal.

According to an embodiment of the invention, a color code of an outer surface of the first casing is a combination of color codes greater than R60, G20, and B30.

According to an embodiment of the invention, the integrating sphere cover further includes a second casing. The second casing partially covers the integrating sphere and includes a second opening. The integrating sphere includes a light exit that passes through the second opening. A curvature radius of the second casing is greater than the curvature radius of the integrating sphere. The fixing assembly fixes relative positions of the second casing and the integrating sphere. When the second casing covers other portions of the integrating sphere, a second interval communicating with the second opening is between the second casing and the integrating sphere, so as to form a second hollow intermediate layer between the second casing and the integrating sphere. The first hollow intermediate layer communicates with the second hollow intermediate layer. The air flow passes through the first hollow intermediate layer and the second hollow intermediate layer via the nozzle, the first opening, and the second opening.

As provided above, in the integrating sphere module provided herein, the integrating sphere cover is arranged to cover at least one portion of the integrating sphere. The curvature radius of the first casing is greater than the curvature radius of the integrating sphere. When the first casing covers the integrating sphere, the first hollow intermediate layer is sandwiched between the first casing and the integrating sphere. Since the first hollow intermediate layer communicates with the nozzle and the first opening, the air flow is able to pass through the first hollow intermediate layer via the nozzle and the first opening. As such, when a heating module heats the LED to perfolin the heat inspection, the first casing located between the heating module and the integrating sphere can control the air flow to flow within the first hollow intermediate layer, so as to effectively reduce the possibility of transferring the heat to the integrating sphere. Thereby, the temperature of the integrating sphere can stay low.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view illustrating a test system of an optical illumination device according to an embodiment of the invention.

FIG. 2 is a schematic view illustrating the integrating sphere module depicted in FIG. 1.

FIG. 3 is a schematic exploded view of FIG. 2.

FIG. 4 is a schematic cross-sectional view of FIG. 2.

FIG. 5 is a schematic view illustrating an integrating sphere module according to another embodiment of the invention.

FIG. 6 is a schematic exploded view of FIG. 5.

FIG. 7 is a schematic cross-sectional view of FIG. 5.

### DESCRIPTION OF EMBODIMENTS

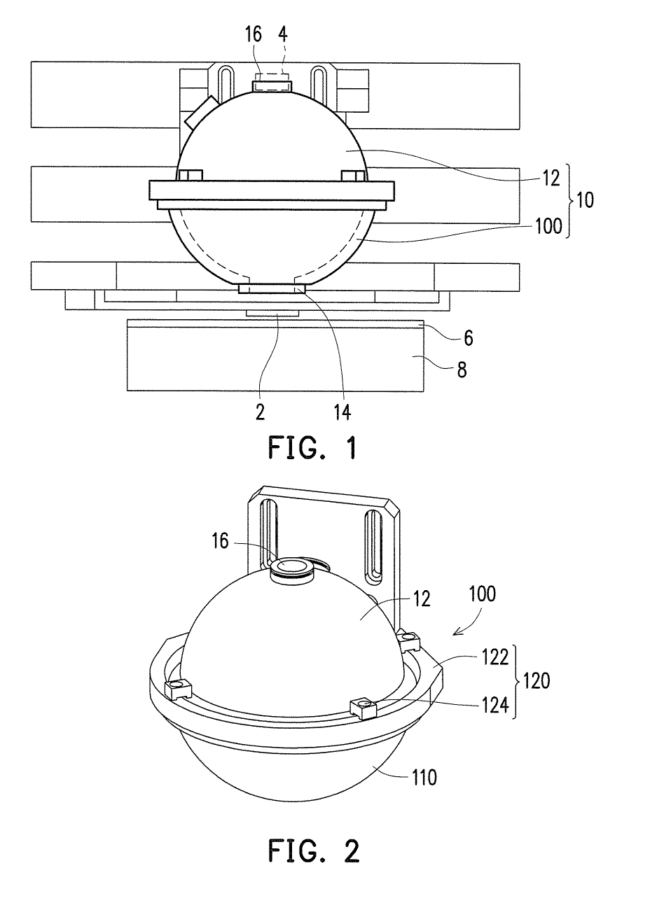

FIG. 1 is a schematic view illustrating a test system of an optical illumination device according to an embodiment of the invention. In FIG. 1, the optical illumination device is LEDs or the like, and the type of the optical illumination device is not limited herein. A wafer 6 having a plurality of LEDs (not shown in FIG. 1) is used in the test system to perform optical and temperature tests. A probe module 2 and an integrating sphere 12 are arranged above the wafer 6. The probe module 2 is located around a light receiving entrance 14 of the integrating sphere 12. When the probe module 2 is in contact with electrodes of the LEDs of the wafer 6, the probe module 2 provides electricity to the LEDs. The light emitted by the LEDs enters the integrating sphere 12 through the light receiving entrance 14. The integrating sphere 12 is constituted by a hollow sphere, and an inner wall of the sphere is coated with a material coating layer (e.g., a barium sulfate layer) with significant diffuse reflection, so as to achieve diffusion effects and uniformize the light. A light sensing module 4 is located on a light exit 16 of the integrating sphere 12, so as to detect the optical properties of the light emitted from the LEDs.

Besides, the test system also conducts the heat test on the LEDs. In the present embodiment, the heating module 8 is located below the wafer 6, so as to heat the LEDs of the wafer 6 and perform the heat test. As shown in FIG. 1, the integrating sphere 12 is close to the LEDs. In order to prevent the integrating sphere 12 from being heated while the LEDs are being heated, an integrating sphere cover 100 covers at least one portion of the integrating sphere 12 in the present embodiment; more particularly, the integrating sphere cover 100 on the integrating sphere 12 is arranged close to the heating module 8, so as to reduce the possibility of transferring the heat to the integrating sphere 12. Detailed elaborations are provided hereinafter.

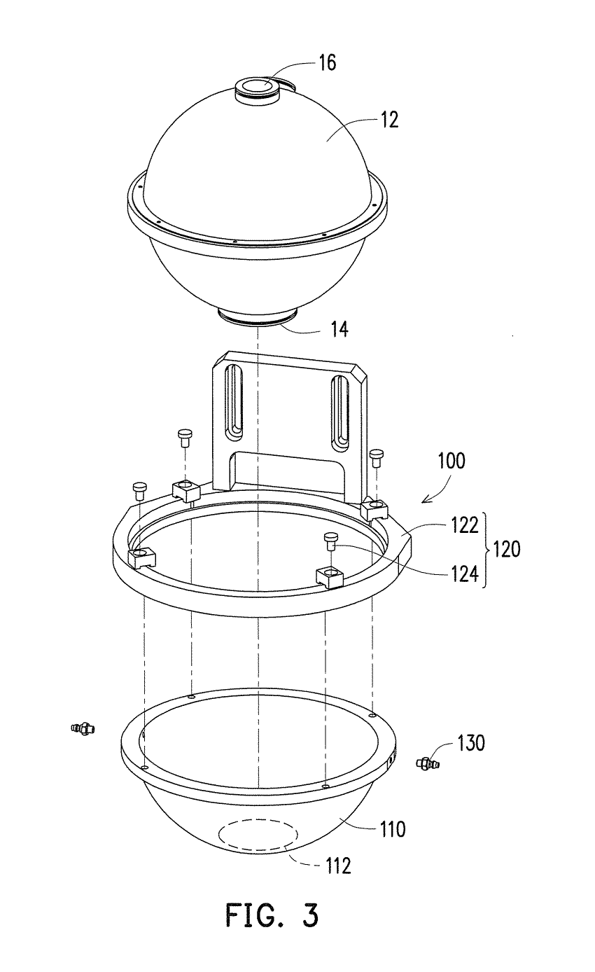

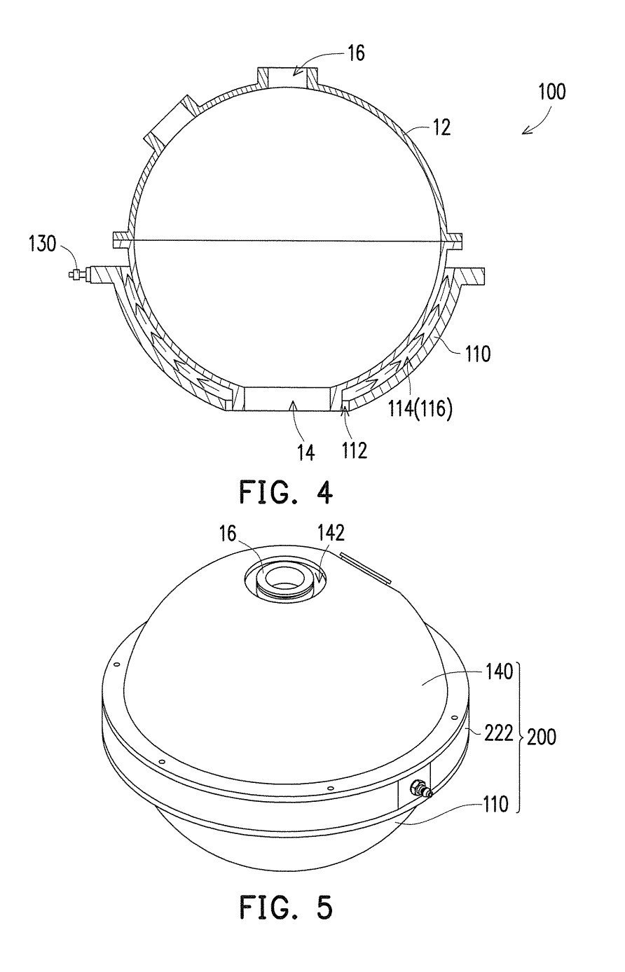

FIG. 2 is a schematic view illustrating the integrating sphere module depicted in FIG. 1. FIG. 3 is a schematic exploded view of FIG. 2. FIG. 4 is a schematic cross-sectional view of FIG. 2. With reference to FIG. 1 to FIG. 4, an integrating sphere module 10 provided in the present embodiment includes the integrating sphere 12 and the integrating sphere cover 100. In the present embodiment, the integrating sphere cover 100 covers one portion of the integrating sphere 12; however, in another embodiment, the integrating sphere cover 100 may cover the entire integrating sphere 12. According to the present embodiment, the integrating sphere cover includes a first casing 110 and a fixing assembly 120.

The first casing 110 is a hollow semi-sphere and covers a lower portion of the integrating sphere 12. The first casing 110 includes a first opening 112, and the light receiving entrance 14 passes through the first opening 112. A curvature radius of the first casing 110 is greater than a curvature radius of the integrating sphere 12; hence, when the first casing 110 covers the integrating sphere 12, a first interval 114 is between the first casing 110 and the integrating sphere 12. The first interval 114 allows the formation of a first hollow intermediate layer 116 between the first casing 110 and the integrating sphere 12. A nozzle 130 is located at the first casing 110. The first hollow intermediate layer 116 communicates with the first opening 112 and the nozzle 130, as shown in FIG. 4, and an air flow is adapted to pass through the first hollow intermediate layer 116 via the nozzle 130 and the first opening 112.

In the present embodiment, the first casing 110 may be a heat insulating member, and a material of the heat insulating member includes plastic, plastic steel, or backlite. Note that the type of the material of the heat insulating member is not limited herein. When the heating module 8 starts to heat the LEDs of the wafer 6, the first casing 110 of the integrating sphere cover 100 between the integrating sphere 12 and the heating module 8 insulates some heat, and thus only the remaining heat can be transferred toward the integrating sphere 12. In addition, due to the first hollow intermediate layer 116 between the first casing 110 and the integrating sphere 12, it is possible to generate a negative or positive pressure through performing an air pumping or filling process at the first opening 112 or the nozzle 130, such that an air flow can be generated in the air channel constituted by the first opening 112, the first hollow intermediate layer 116, and the nozzle 130. The air flow passing through the first hollow intermediate layer 116 can remove some heat. Hence, the remaining heat transferred to the integrating sphere 12 is insignificant. Thereby, the temperature of the integrating sphere 12 can stay low and is not affected by the heating module 8.

Certainly, in other embodiments, the first casing 110 may also be a heat conductor, and a material of the heat conductor includes metal, e.g., aluminum or copper. In this case, the heat is conducted to the first casing 110, and it is possible to expedite the speed of the air flow within the first hollow intermediate layer 116, so as to rapidly remove the heat. As a result, the temperature of the integrating sphere 12 can stay low. Besides, in other embodiments of the invention, the outer surface of the first casing 110 may be further equipped with a heat dissipation fin (not shown), so as to enhance the heat dissipating efficiency of the first casing 110. It should be mentioned that the direction of the air flow shown in FIG. 4 is merely explanatory, and the actual direction of the air flow can be changed according to actual arrangement and is not limited to that provided herein.

To ensure the light received by the integrating sphere 12 is the light directly emitted by the LEDs, the chromaticity of the first casing 110 is less than 50% according to the present embodiment, such that the outer surface of the first casing 110 is dark, e.g., black, so as to reduce the possibility of light reflection. Specifically, in the present embodiment, a color code of the outer surface of the first casing 110 is a combination of color codes greater than R60, G20, and B30.

Besides, the relative positions of the first casing 110 and the integrating sphere 12 are fixed by the fixing assembly 120 in the present embodiment. Here, the fixing assembly 120 includes a holder 122 and a plurality of locking members 124. The holder 122 may be the original holder of the integrating sphere 12 or any other additional holder. The locking members 124 lock the first casing 110 to the holder 122, and the integrating sphere 12 is fixed to the holder 122, so as to fix the first casing 110 to the integrating sphere 12.

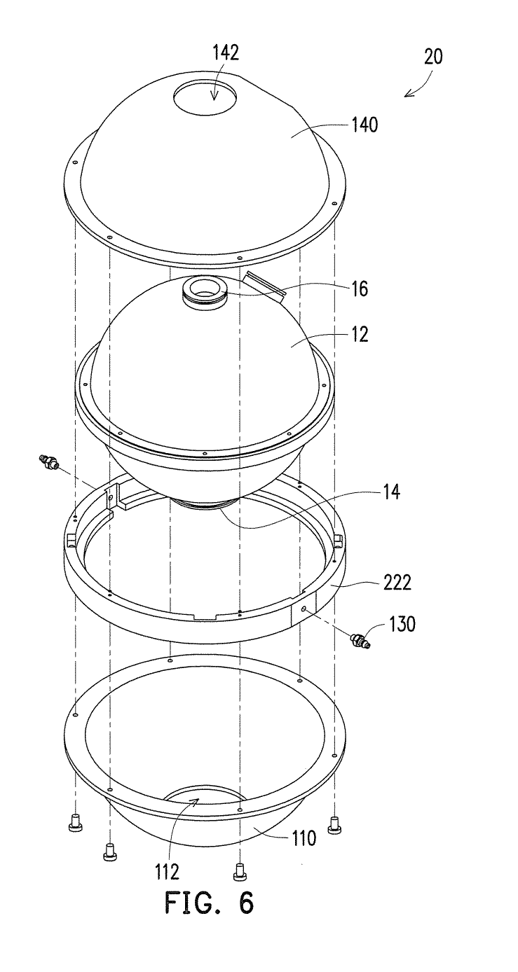

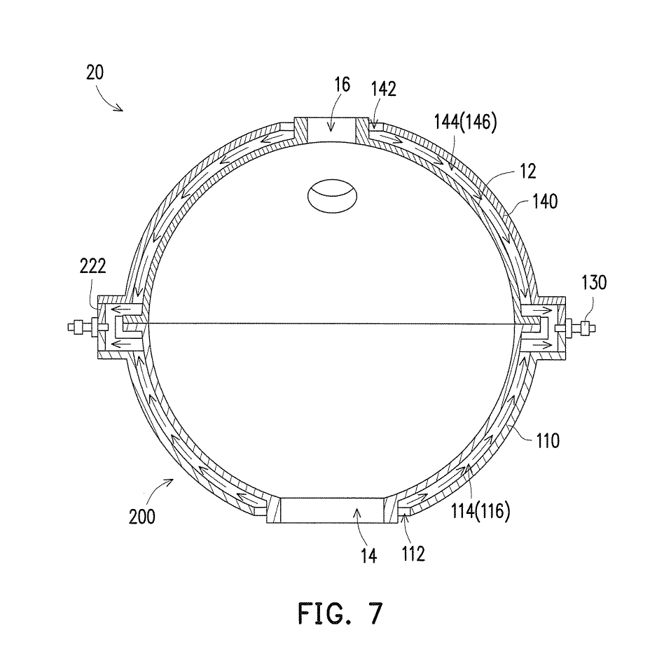

FIG. 5 is a schematic view illustrating an integrating sphere module according to another embodiment of the invention. FIG. 6 is a schematic exploded view of FIG. 5. FIG. 7 is a schematic cross-sectional view of FIG. 5. In the present embodiment, the same or similar devices provided in the previous embodiment and the present embodiments are represented by the same or similar reference numbers and will not be further explained.

With reference to FIG. 5 to FIG. 7, the difference between the integrating sphere module 20 provided in the present embodiment and the integrating sphere module 10 provided in the previous embodiment lies in that the integrating sphere cover 200 in the present embodiment further includes a second casing 140 which is a hollow semi-sphere as well. The second casing 140 covers a portion of the integrating sphere 12 (i.e., an upper portion shown in the drawings) and includes a second opening 142. The light exit 16 of the integrating sphere 12 passes through the second opening 142. The first casing 110 and the second casing 120 collectively cover the integrating sphere 12 but do not cover the light receiving entrance 14 and the light exit 16. In the present embodiment, the type of the holder 222 is slightly different from that provided in the previous embodiment; however, as long as the holder 222 is able to fix the relative positions of the first casing 110, the second casing 140, and the integrating sphere 12, the holder 222 falls within the scope of protection provided herein and should not be further limited. Moreover, in the present embodiment, the nozzle 130 is located on the holder 222, whereas the location of the nozzle 130 should not be construed as a limitation herein.

According to the present embodiment, a curvature radius of the second casing 140 is greater than the curvature radius of the integrating sphere 12. Thereby, when the second casing 140 covers the other portion of the integrating sphere 12, a second interval 144 communicating with the second opening 142 is between the second casing 140 and the integrating sphere 12, so as to form a second hollow intermediate layer 146 between the second casing 140 and the integrating sphere 12. The second hollow intermediate layer 146 communicates with the first hollow intermediate layer 116. The air flow is adapted to pass through the first hollow intermediate layer 116 and the second hollow intermediate layer 146 via the nozzle 130, the first opening 112, and the second opening 142.

In the present embodiment, the curvature radius of the second casing 140 is the same as the curvature radius of the first casing 110; by contrast, in other embodiments of the invention, the curvature radius of the second casing 140 may be different from the curvature radius of the first casing 110. Alternatively, in other embodiments of the invention, the first casing 110 and the second casing 140 may have an irregular shape or may be shaped as hollow squares.

The second casing 140 provided herein may be a heat insulating member, and a material of the heat insulating member includes plastic, plastic steel, or backlite. Note that the type of the material of the heat insulating member is not limited herein In an alternative embodiment, the second casing 140 may be a heat conductor, and a material of the heat conductor includes metal, e.g., aluminum or copper.

When the heating module 8 starts to heat the LEDs of the wafer 6, the first casing 110 and the second casing 140 of the integrating sphere cover 100 between the integrating sphere 12 and the heating module 8 insulate some heat, and thus only the remaining heat can be transferred toward the integrating sphere 12. In addition, due to the first hollow intermediate layer 116 between the first casing 110 and the integrating sphere 12 and the second hollow intermediate layer 146 between the second casing 140 and the integrating sphere 12, it is possible to generate a negative or positive pressure through performing an air pumping or filling process at the first opening 112, the second opening 142, or the nozzle 130, such that an air flow can be generated in the air channel constituted by the first opening 112, the first hollow inteiiiiediate layer 116, the second opening 142, the second hollow intermediate layer 146, and the nozzle 130. The air flow passing through the first hollow intermediate layer 116 and the second hollow intermediate layer 146 can remove some heat, such that the temperature of the integrating sphere 12 can stay low.

To sum up, in the integrating sphere module provided herein, the integrating sphere cover is arranged to cover at least one portion of the integrating sphere. The curvature radius of the first casing is greater than the curvature radius of the integrating sphere. When the first casing covers the integrating sphere, the first hollow intermediate layer is sandwiched between the first casing and the integrating sphere. Since the first hollow intermediate layer communicates with the nozzle and the first opening, the air flow is able to pass through the first hollow intermediate layer via the nozzle and the first opening. As such, when a heating module heats the LED to perform the heat inspection, the first casing located between the heating module and the integrating sphere can control the air flow to flow within the first hollow intermediate layer, so as to effectively reduce the possibility of transferring the heat to the integrating sphere. Thereby, the temperature of the integrating sphere can stay low.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. An integrating sphere cover adapted to cover at least one portion of an integrating sphere, the integrating sphere comprising a light receiving entrance, the integrating sphere cover comprising:
a first casing adapted to partially cover the integrating sphere and comprising a first opening, the light receiving entrance passing through the first opening, a curvature radius of the first casing being greater than a curvature radius of the integrating sphere; and
a fixing assembly disposed at the first casing, the first casing being adapted to be fixed to the integrating sphere through the fixing assembly, the first casing or the fixing assembly comprising a nozzle,
wherein when the first casing covers the integrating sphere, a first interval communicating with the first opening and the nozzle is between the first casing and the integrating sphere, so as to fonn a first hollow intemiediate layer between the first casing and the integrating sphere, and an air flow passes through the first hollow intermediate layer via the nozzle and the first opening.

2. The integrating sphere cover according to claim 1, wherein the fixing assembly comprises a holder and a plurality of locking members locking the first casing to the holder, and the integrating sphere is adapted to be fixed to the holder.

3. The integrating sphere cover according to claim 1, wherein the first casing is a heat insulating member and a material of the heat insulating member comprises plastic, plastic steel, or backlite, or the first casing is a heat conductor and a material of the heat conductor comprises metal.

4. The integrating sphere cover according to claim 1, wherein a color code of an outer surface of the first casing is a combination of color codes greater than R60, G20, and B30.

5. The integrating sphere cover according to claim 1, further comprising:
a second casing adapted to partially cover the integrating sphere and comprising a second opening, the integrating sphere comprising a light exit passing through the second opening, a curvature radius of the second casing being greater than the curvature radius of the integrating sphere, the fixing assembly being disposed at the second casing, the second casing being adapted to be fixed to the integrating sphere through the fixing assembly,
wherein when the second casing covers other portions of the integrating sphere, a second interval between the second casing and the integrating sphere communicates with the second opening, so as to form a second hollow intermediate layer between the second casing and the integrating sphere, and the air flow passes through the first hollow intermediate layer and the second hollow intermediate layer via the nozzle, the first opening, and the second opening.

6. An integrating sphere module comprising:
an integrating sphere comprising a light receiving entrance; and
an integrating sphere cover covering at least one portion of the integrating sphere and comprising:
a first casing partially covering the integrating sphere and comprising a first opening, the light receiving entrance passing through the first opening, a curvature radius of the first casing being greater than a curvature radius of the integrating sphere; and
a fixing assembly fixing relative positions of the first casing and the integrating sphere, the first casing or the fixing assembly comprising a nozzle,
wherein a first interval communicating with the first opening and the nozzle is between the first casing and the integrating sphere, so as to fonn a first hollow intermediate layer between the first casing and the integrating sphere, and an air flow passes through the first hollow intermediate layer via the nozzle and the first opening.

7. The integrating sphere module according to claim 6, wherein the fixing assembly comprises a holder and a plurality of locking members fixing the first casing to the holder, and the integrating sphere is adapted to be fixed to the holder.

8. The integrating sphere module according to claim 6, wherein the first casing is a heat insulating member and a material of the heat insulating member comprises plastic, plastic steel, or backlite, or the first casing is a heat conductor and a material of the heat conductor comprises metal.

9. The integrating sphere module according to claim 6, wherein a color code of an outer surface of the first casing is a combination of color codes greater than R60, G20, and B30.

10. The integrating sphere module according to claim 6, wherein the integrating sphere cover further comprises:
a second casing partially covering the integrating sphere and comprising a second opening, the integrating sphere comprising a light exit passing through the second opening, a curvature radius of the second casing being greater than the curvature radius of the integrating sphere, the fixing assembly being fixed to relative locations of the second casing and the integrating sphere,
wherein when the second casing covers other portions of the integrating sphere, a second interval communicating with the second opening is between the second casing and the integrating sphere, so as to form a second hollow intermediate layer between the second casing and the integrating sphere, the second hollow intermediate layer communicates with the first hollow intermediate layer, and the air flow passes through the first hollow intermediate layer and the second hollow intermediate layer via the nozzle, the first opening, and the second opening.
